(19) United States
(12) Patent Application Publication
(10) Pub. No.: US 2025/0027522 A1
(43) Pub. Date: Jan. 23, 2025

(54) SCREW, TOOL AND ARRANGEMENT WITH A SCREW AND A TOOL

(71) Applicant: SCHMID SCHRAUBEN HAINFELD GMBH, Hainfeld (AT)

(72) Inventors: Gerhard Leb, Kirchberg (AT); Philip Kubinger, Boeheimkirchen (AT)

(21) Appl. No.: 18/715,632

(22) PCT Filed: Nov. 28, 2022
(86) PCT No.: PCT/EP2022/083482

§ 371 Date: May 31, 2024

(30) Foreign Application Priority Data
Dec. 1, 2021 (DE) 10 2021 213 643.5

(51) Int. Cl. F16B 23/00; B25B 15/00

(52) U.S. Cl. CPC F16B 23/003; B25B 15/005; F16B 23/0053

(57) ABSTRACT

The invention relates to a screw (10; 70) with a shank (12), a thread (14) on at least one portion of the shank (12), wherein the thread (14) defines a screwing-in direction about a centre longitudinal axis of the shank (12), and with a drive formation (18; 78) at one end of the shank (12), wherein the drive formation (18; 78) has a depression (20; 80) in a screw head (16) or a projection at the end of the shank (12), wherein the depression (20; 80) or the projection in each case has a circular-cylindrical or frustoconical main body (22; 82), arranged concentrically with respect to a centre longitudinal axis (26) of the shank (12), and a number of protuberances (24; 84) which extend away from the main body (22; 82), wherein the protuberances (24; 84) are of rounded configuration at their radially outer ends, characterized in that the protuberances (24; 84) extend with a radial component with respect to the centre longitudinal axis (26), and with a component which is oriented tangentially and counter to the screwing-in direction.

The invention relates to a screw with a shank, a thread on at least one portion of the shank, wherein the thread defines a screwing-in direction about a center longitudinal axis of the shank, and with a drive formation at one end of the shank, wherein the drive formation has a depression in a screw head or a projection at the end of the shank, wherein the depression or the projection in each case has a circular-cylindrical or frustoconical main body arranged concentrically with respect to a center longitudinal axis of the shank, and a number of protuberances which extend away from the main body, wherein the protuberances are of rounded configuration at their radially outer ends. The invention further relates to a tool for screwing-in and unscrewing a screw according to the invention, as well as an arrangement with a screw according to the invention and a tool according to the invention.

A screw, a tool and an arrangement with a screw and a tool are designed to be improved by the invention, such that a simpler processing of screws, in particular a reduced effort, is achieved.

According to the invention, to this end a screw is provided with a shank, a thread on at least one portion of the shank, wherein the thread defines a screwing-in direction about a center longitudinal axis of the shank, and with a drive formation at one end of the shank, wherein the drive formation has a depression in a screw head or a projection at the end of the shank, wherein the depression or the projection in each case has a circular-cylindrical or frustoconical main body arranged concentrically with respect to a center longitudinal axis of the shank, and a number of protuberances which extend away from the main body, wherein the protuberances are of rounded configuration at their radially outer ends, wherein the protuberances extend with a radial component with respect to the center longitudinal axis and with a component which is oriented tangentially and counter to the screwing-in direction.

In other words, the protuberances are thus arranged obliquely to the circumferential direction and inclined counter to the screwing-in direction. According to the invention, the drive formation can be configured as a depression so that the main body and the protuberances thus define a cohesive cavity or empty space. According to the invention, the drive formation can also be configured as a projection so that the main body and the protuberances thus form a common body or a cohesive volume consisting of the material of the screw. It has been shown that the screw according to the invention with its drive formation is positioned securely on a matching tool which thus has a correspondingly shaped projection or a correspondingly shaped depression, in particular a screwdriver bit, and that less effort is required when screwing-in the screw. It has been established by statistical evaluation, in particular, that less electrical energy is required from a cordless screwdriver for screwing-in a screw according to the invention than for screwing-in a conventional screw. In the screw according to the invention, the screwing-in force, which is in the circumferential direction, is transmitted via surfaces located obliquely to the screwing-in force. The surfaces are arranged so as to be trailing with respect to the rotational direction when screwing in. The driving surfaces on the tool can bear flat against the driven surfaces on the screw. The driving surfaces on the tool can be curved outwardly. The driven surfaces on the screw can be curved so as to match the driving surfaces, resulting in the driving surfaces bearing flat against the driven surfaces. A substantial advantage of the screw according to the invention is that it can also be processed with known tools, in particular drive bits, for example for 6-lobe or Torx. This is primarily achieved by the depression or the projection having in each case a circular-cylindrical main body arranged concentrically to a center longitudinal axis of the shank. The screw according to the invention can be screwed in or unscrewed again by means of the drive formation. The advantages according to the invention, in particular the reduced effort relative to conventional screws, occur primarily when screwing-in the screw due to the inclination of the protuberances counter to the screwing-in direction.

In a development of the invention, a leading side surface of the protuberances in the screwing-in direction has a larger surface area than a trailing side surface of the protuberances in the screwing-in direction.

This results in an improved and flat bearing of the leading side surface of the protuberances in the screwing-in direction against the matching side surfaces of the tool, due to the larger side surface relative to conventional screws. It is assumed that, due to this flat bearing of the leading side surfaces in the screwing-in direction, smaller mechanical losses occur when screwing in a screw according to the invention than when screwing in a conventional screw. The unscrewing naturally takes place in the reverse direction. Generally smaller torques occur when unscrewing, so that the smaller trailing side surface of the protuberances in the screwing-in direction relative to conventional screws is not critical.

In a development of the invention, between three and six protuberances are provided.

Between three and six protuberances, for example three, four, five or six protuberances, have proved advantageous with respect to the manufacturability, a secure seat and with respect to an improved force transmission when screwing-in.

In a development of the invention, the defining surfaces of the protuberances are arranged parallel to the center longitudinal axis.

In this manner, when screwing-in, an axial force which acts on the tool and which drives the tool out of the depression of the drive formation of the screw, or away from the projection of the drive formation of the screw, is avoided.

In a development of the invention, the defining surfaces of the protuberances are arranged at an angle of more than 0° and less than 10°, in particular 6°, obliquely to the center longitudinal axis.

It has been shown that an angle of 6° is advantageous. An axial force which is produced when screwing-in and which pushes the tool out of the depression of the drive formation, or away from a projection when screwing-in, is thus small and able to be easily controlled by a user. All of the intermediate angles between 0° and 10°, in particular 1°, 2°, 3°, 4°, 5°, 6°, 7°, 8° and 9° are hereby expressly disclosed.

In a development of the invention, the drive formation is configured as a depression and a cross section of the depression reduces in the direction of the screw tip.

In this manner, the manufacturability of the screw according to the invention is significantly facilitated, since the drive formation is generally pressed into the screw head. A punch for pressing in the drive formation can thus be simply pulled out again. Moreover, such a configuration of the drive formation facilitates the insertion of a tool, in particular a screwdriver bit.

In a development of the invention, the drive formation is configured as a depression and a closed end of the depression is of conical configuration.

A conical configuration of the closed end of the recess can ensure a uniform force distribution in the material of the screw head when screwing-in. In particular, a greater residual thickness of the material of the screw head is achieved than with a cylindrical recess due to a conical end of the recess.

In a development of the invention, the drive formation is configured as a projection and a cross section of the projection increases in the direction of the screw tip.

In this manner, a tool can be placed in a very simple manner on the projection of the drive formation on the screw and also removed again therefrom. An angle at which the cross section of the projection increases in the direction of the screw tip should be more than 0° and less than 10°, in particular 6°, for example. With an angle of 6°, the tool can be placed in a simple manner on the projection of the drive formation of the screw and also removed again therefrom. However, the axial force which inevitably acts on the tool when screwing in or unscrewing the screw, and forces this tool away from the drive formation of the screw, is not great and can be easily applied and thus controlled by a user.

In a development of the invention, when viewed parallel to the center longitudinal axis, in all protuberances a tangent or parallel line to the leading side surface of the protuberance in the screwing-in direction encloses an angle of between 25° or 50°, in particular 35°, with a radial direction which runs through the point of the protuberance located furthest to the outside in the radial direction.

All of the intermediate angles between 25° and 50° are hereby expressly disclosed. An angle of between 25° and 50°, in particular 35°, about which the leading side surfaces in the screwing-in direction are inclined relative to the radial direction, contributes to the advantageous effects of the screw according to the invention.

In a development of the invention, when viewed in a cross section perpendicular to the center longitudinal axis, the leading side surfaces of the protuberances in the screwing-in direction are curved outwardly.

The outwardly curved leading side surfaces in the screwing-in direction, when screwing in the screw, ensure the self-centering of the matching tool in the drive formation of the screw.

In a development of the invention, a radius of curvature of the leading side surfaces in the screwing-in direction is between two-times and three-times a diameter of the cylindrical or frustoconical main body.

For example, the radius of curvature of the leading side surfaces in the screwing-in direction, when viewed parallel to the center longitudinal axis, is 13 mm. A diameter of the cylindrical main body or the largest diameter of the frustoconical main body is thus, for example, 5.1 mm.

In a development of the invention, a ratio of a diameter of the cylindrical or frustoconical main body and a diameter of an imaginary circumference of the recess or the projection is a maximum of 1:1.4, in particular 1:1.38.

With such a dimension of the ratio of the diameter of the cylindrical main body or the largest diameter of the frustoconical main body and the diameter of an imaginary circumference of the recess or the projection, the screw according to the invention can be processed easily with drive formations for 6-lobe or even Torx.

The problem underlying the invention is also achieved by a tool for screwing in and unscrewing a screw according to at least one of the preceding claims, with a drive formation which is configured to match the drive formation of the screw, in which the drive formation has a projection or a depression, wherein the projection or the depression in each case has a circular-cylindrical or frustoconical main body arranged concentrically with respect to a center longitudinal axis of the shank, and a number of protuberances which extend away from the main body, wherein the protuberances are of rounded configuration at their radially outer ends, wherein relative to the center longitudinal axis the protuberances extend with a radial component with respect to the center longitudinal axis and with a component which is oriented tangentially and counter to the screwing-in direction.

In other words, the protuberances of the tool are also arranged obliquely to the circumferential direction and inclined counter to the screwing-in direction.

In a development of the invention, at least the leading side surfaces of the protuberances or the projection in the screwing-in direction have a mean roughness value Rₐ of a maximum of 0.4 μm.

It has been shown that the effort when screwing-in can be reduced in this manner. It is assumed that by processing the leading side surfaces in the screwing-in direction by grinding or even polishing, an improved surface contact of the leading side surfaces of the protuberances of the tool in the screwing-in direction is achieved on the side surfaces of the protuberances of the drive formation of the screw. It is assumed that an improved or increased surface contact can reduce the mechanical losses and thus the effort when screwing in the screw.

In a development of the invention, the drive formation is configured as a projection and a cross section of the projection reduces in the direction of its free end, wherein the free end is arranged in the depression of the screw.

In a development of the invention, the defining surfaces of the protuberances are arranged at an angle of 0° to 10°, in particular more than 0° and less than 10°, in particular 6°, obliquely to the center longitudinal axis.

An angle of 6° is advantageous since with such an angle the tool or the drive bit can be easily introduced into the depression in the screw head and at the same time an axial force when screwing-in, which attempts to push the drive bit out of the depression of the screw, is small and can be easily applied and thus controlled by a user. All of the intermediate values between 0° and 10°, in particular 1°, 2°, 3°, 4°, 5°, 6°, 7°, 8°, 9°, can be used.

The problem underlying the invention is also achieved by an arrangement with a screw according to the invention and a tool according to the invention, wherein the outwardly curved leading side surfaces of the drive formation of the tool in the screwing-in direction bear flat against the outwardly curved leading side surfaces of the drive formation of the screw in the screwing-in direction when applying a torque in the screwing-in direction by means of the tool.

In a development of the invention, when viewed in the direction of the center longitudinal axis of the tool and screw, the leading side surfaces of the tool in the screwing-in direction bear flat over their entire length against the leading side surfaces of the screw in the screwing-in direction.

Further features and advantages of the invention are found in the claims and the following description of preferred embodiments of the invention in connection with the drawings. Individual features of the various embodiments shown and/or described can be combined in any manner with one another without departing from the scope of the invention. This also applies to the combination of individual features, without the further individual features with which they are disclosed in combination. In the drawings:

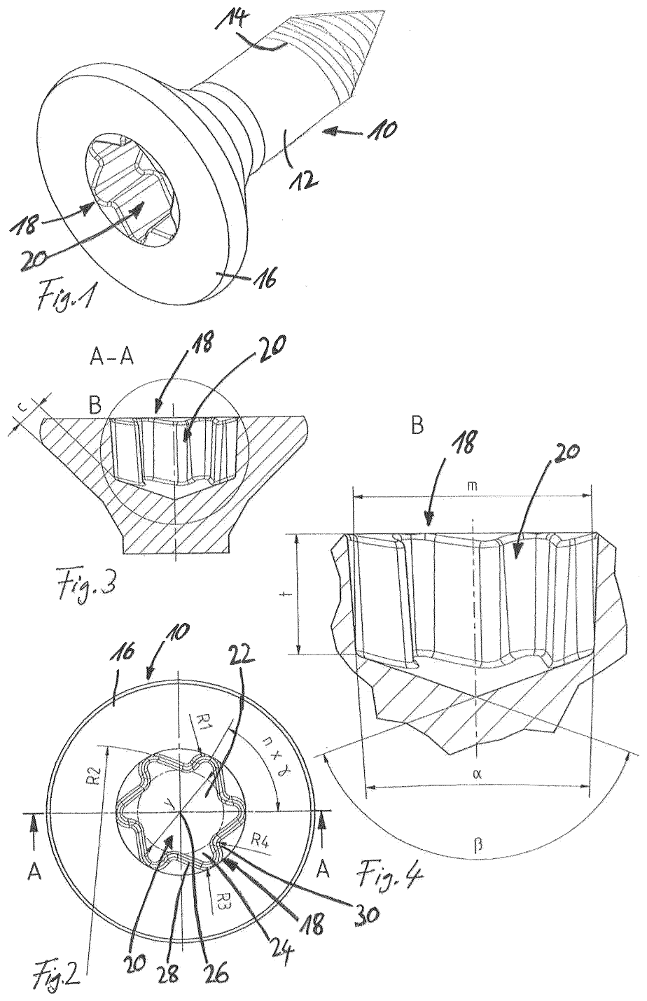

FIG. 1 shows a perspective view of a screw according to the invention according to a first embodiment obliquely from the rear,

FIG. 2 shows a plan view of the screw head of the screw of FIG. 1,

FIG. 3 shows a sectional view of the cutting plane A-A in FIG. 2,

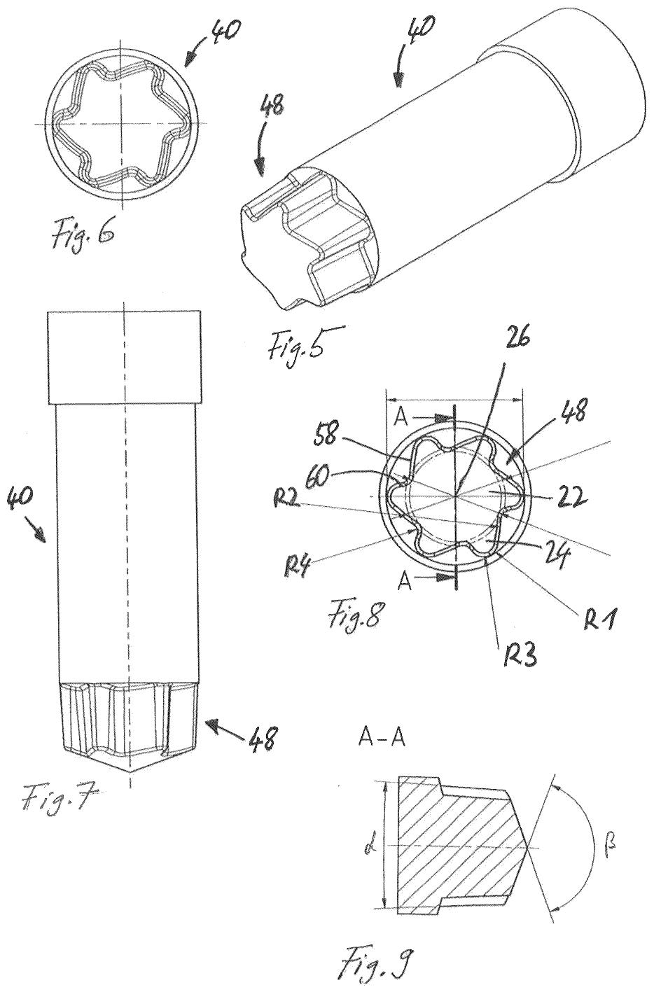

FIG. 4 shows the enlarged detail B of FIG. 3,

FIG. 5 shows a perspective view of a drive bit, i.e. of a tool, for screwing in and unscrewing the screw shown in FIG. 1,

FIG. 6 shows a front view of the tool of FIG. 5,

FIG. 7 shows a side view of the tool of FIG. 5,

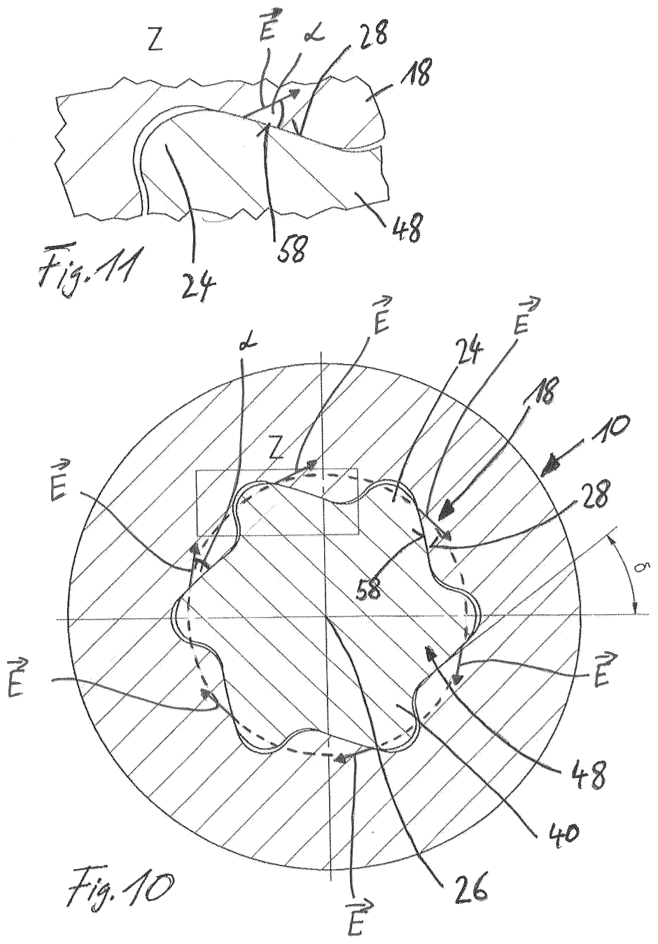

FIG. 8 shows a front view similar to FIG. 6, wherein auxiliary lines are illustrated,

FIG. 9 shows a sectional view of the cutting plane A-A in FIG. 8,

FIG. 10 shows a view of a cutting plane through an arrangement with the screw of FIG. 1 and the tool of FIG. 5, wherein the cutting plane runs perpendicularly to the center longitudinal axis of the screw and the tool,

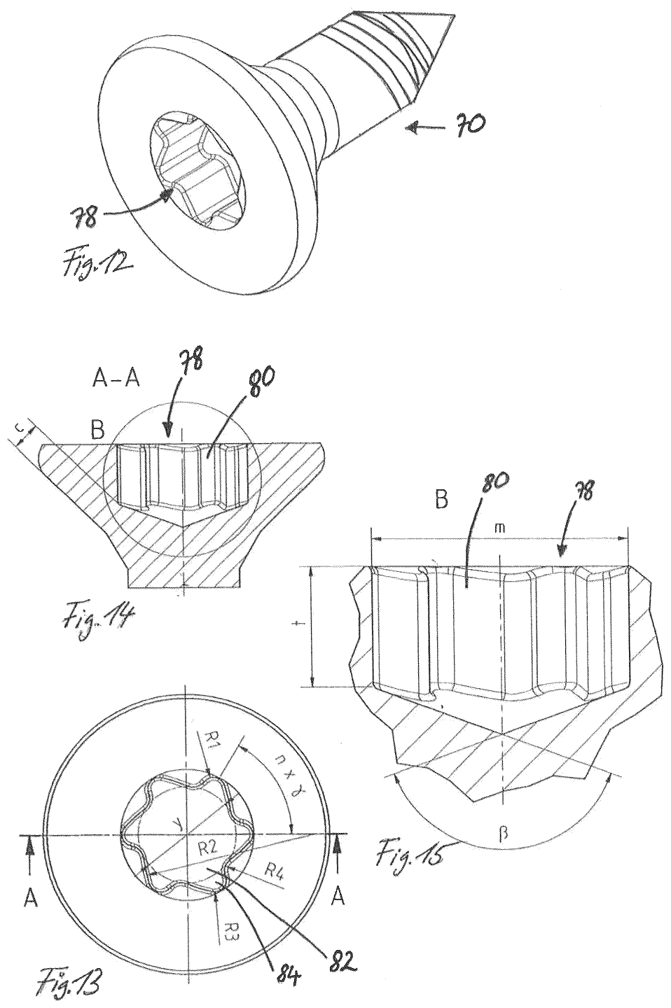

FIG. 11 shows an enlarged view of the detail Z of FIG. 10,

FIG. 12 shows a perspective view of a screw according to the invention according to a second embodiment obliquely from the rear,

FIG. 13 shows a plan view of the screw of FIG. 1,

FIG. 14 shows a view of the cutting plane A-A in FIG. 13,

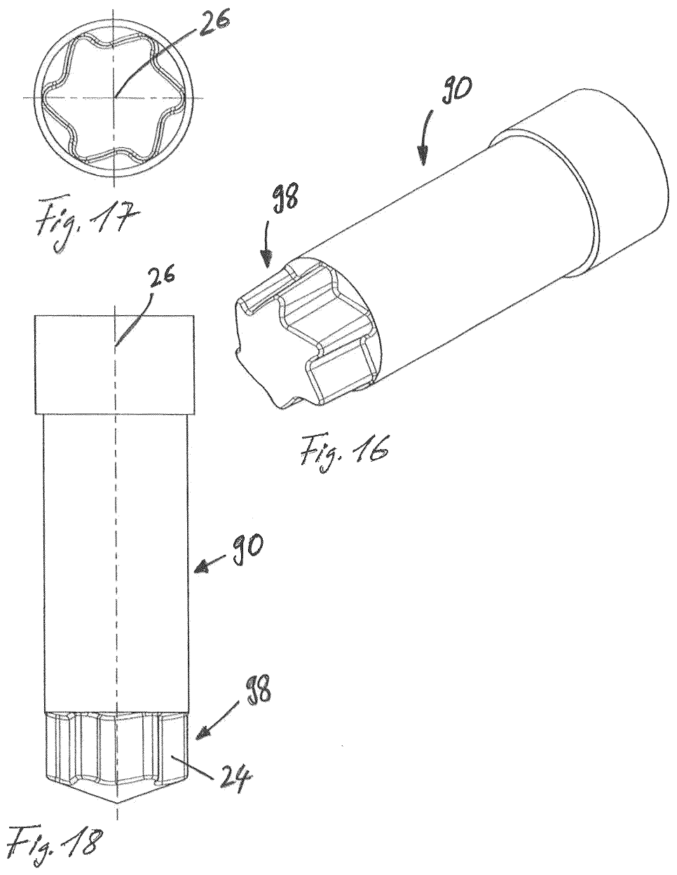

FIG. 15 shows the enlarged detail B of FIG. 14,

FIG. 16 shows a tool in the form of a drive bit for screwing in the screw of FIG. 12,

FIG. 17 shows a front view of the tool of FIG. 16 and

FIG. 18 shows a side view of the tool of FIG. 16.

FIG. 1 shows a screw 10 according to the invention according to a first embodiment of the invention. The screw 10 has a shank 12 and a thread 14 on a portion of the shank 12. The shank 12 tapers toward one end and the screw 10 is provided with a screw head 16 on the end opposing the tapering end. The screw head 16 is provided with a drive formation 18 which has a depression 20. The design of the drive formation 18 is important for the invention. The design of the shank 12, the thread 14 and the screw head 16 is of less importance for the invention and can be modified within the scope of the invention or even configured differently in principle.

FIG. 2 shows a plan view of the screw head 16 of the screw 10 of FIG. 1, wherein the design of the drive formation 18 can be more clearly identified in the plan view and thus is described further with reference to FIG. 2.

It can be identified in FIG. 2 that the depression 20 of the drive formation 18 has a frustoconical main body 22. The main body 22 is indicated by a dashed circular line with the diameter y in FIG. 2, wherein the dashed circular line with the diameter y merely represents an imaginary line. The frustoconical shape of the main body 22 in FIG. 2 can barely be identified but can be seen in FIG. 5, for example. The cone angle α is, for example, 6°. Protuberances 24 extend away from the main body 22. A total of six protuberances 24 extend away from the main body 22. The protuberances 24 are configured to be rounded on their radially outer ends. The protuberances 24 extend with a radial component with respect to the center longitudinal axis 26 and at the same time with a tangential component with respect to the center longitudinal axis. In other words, the protuberances 24 are thus arranged obliquely to the radial direction and also obliquely to the circumferential direction. The screw 10 shown in FIG. 2 would be screwed in in the clockwise direction. The protuberances 24 are thus inclined counter to the screwing-in direction. As a result, a leading side surface 28 of the protuberances 24 in the screwing-in direction is larger than a trailing side surface 30 in the screwing-in direction.

An angle γ is located between a point of a protuberance 24 located radially furthest to the outside and the point of the adjacent protuberance 24 located furthest to the outside in the radial direction. In the embodiment shown, this angle is 60°. Since six protuberances 24, which in each case assume an angle of 60°, are provided, this results in the angle of 360° overall. If only four protuberances 24 were to be provided, the protuberances 24 in each case would extend over an angle of 360° divided by four. With only three protuberances 24, the angle γ which each protuberance 24 assumes would be 120°.

In FIG. 2 auxiliary lines are illustrated in order to describe more accurately the geometric configuration of the protuberances 24. The leading side surfaces 28 in the screwing-in direction, when viewed from the center axis, are curved outwardly and have a radius R2. The trailing side surfaces 30 in the screwing-in direction, when viewed from the center longitudinal axis, are also curved outwardly and have a radius R1. A transition between a leading side surface 28 in the screwing-in direction and a trailing side surface 30 in the screwing-in direction of the same protuberance 24 is curved outwardly and has a radius R3. A transition between the trailing side surfaces 30 in the screwing-in direction and the leading side surface 28 of the following protuberance 24 in the screwing-in direction, when viewed from the center longitudinal axis 26, is curved inwardly and has a radius R4. R2 is the largest radius. R3 is smaller than R2. R1 is in turn slightly smaller than R3. R4 is the smallest radius. For example, R2 is 13 mm, R3 is 0.8 mm, R1 is 0.7 mm and R4 is 0.5 mm. With such dimensions, the diameter y of the imaginary circular cylinder of the depression would be approximately 5 mm. A circumference around the drive formation 18 would then have a diameter of 7 mm.

In the context of the invention, the radius of curvature R2 of the leading side surfaces 28 in the screwing-in direction can be between two times and three times the largest diameter of the frustoconical or circular cylindrical main body 22—according to a further embodiment. When viewed parallel to the center longitudinal axis 26, i.e. in the view of FIG. 2, in the context of the invention a ratio of the diameter y of the main body 22 and the diameter of the imaginary circumference of the drive formation 18 can be a maximum of 1:1.4, in particular 1:1.38. Due to a tapering configuration of the depression 20 of the drive formation 18 in the direction of the screw tip, as shown in FIG. 2, this ratio can slightly change in the course of the depression as a function of the vertical position in which the ratio is determined.

FIG. 3 shows a view of the cutting plane A-A in FIG. 2. The depression 20 of the drive formation which has a conical base can be identified. In FIG. 3 the remaining wall thickness c of the screw head is also illustrated. It can already be identified in FIG. 3 that the depression 20 tapers in the direction of the screw tip, i.e. downwardly in FIG. 3.

The enlarged view of the detail B in FIG. 4 illustrates the angle α in which the depression 20 tapers in the direction of the screw tip. This angle α can be measured at the side surfaces of the protuberances 24 but forms the cone angle of the frustoconical main body 22. A cone angle of the conical end of the depression 20 is marked as the angle β. The depth of the depression 20 is specified by t. A width or the diameter of a circumference of the protuberances 24 at the transition with the conical end of the depression 20 is marked by m.

FIG. 5 shows a tool 40 in the form of a drive bit which can be used for screwing in the screw 10 of FIGS. 1 to 4. The tool 40 shows a drive formation 48 which is configured to match the drive formation 18 of the screw 10.

On the basis of the plan view of FIG. 8 it can be identified that the drive formation 48 has a frustoconical main body 22 from which a total of six protuberances 24 extend. The protuberances 24 extend on the tool with a radial component with respect to the center longitudinal axis 26 and a component oriented tangentially and counter to a screwing-in direction. In the view of FIG. 8, the screwing-in direction for the screw 10 of FIG. 1 runs counterclockwise.

As can be identified in FIG. 5, the protuberances 24 are configured on the tool 40 as solid volumes, in contrast to the protuberances 24 of the drive formation 18 of the screw which are configured as empty spaces. The protuberances 24 are arranged obliquely to the circumferential direction and are inclined counter to the screwing-in direction. The leading side surfaces 58 in the screwing-in direction are larger than the trailing side surfaces 60 in the screwing-in direction. The protuberances 24 are rounded at their external end and also the transitions between two protuberances 24 are configured to be rounded. The radii of the individual surfaces which make up the protuberances 24 are denoted in FIG. 8 by the same letters R1, R2, R3 and R4, as in FIG. 2. The ratios of the radii R1, R2, R3 and R4 are the same as have been described on the basis of the screw 10 and, in particular, FIG. 2.

FIG. 6 shows a side view of the tool 40 of FIG. 5. In this view it can be identified that the drive formation 48 tapers in the direction of the free end of the tool 40, at the bottom in FIG. 7, or the cross-sectional surface reduces. This can also be identified in the sectional view of the cutting plane A-A in FIG. 9. The angle α at which the drive formation 48 of the tool 40 tapers is 6°, as in the drive formation 18 of the screw, see FIG. 4, and can be between 0° and 10° according to the invention.

FIG. 10 shows a sectional view through an arrangement consisting of the tool 40 and screw 10, wherein the cutting plane runs perpendicularly to the center longitudinal axis 26 and through the drive formation 18 of the screw 10 and the drive formation 48 of the tool 40. The screwing-in direction runs clockwise in FIG. 10. It can be identified that the leading side surfaces 58 of the drive formation 48 of the tool 40 in the screwing-in direction bear flat against the leading side surfaces 28 of the drive formation 18 of the screw 10 in the screwing-in direction. In the region of the radial outer ends of the protuberances 24, however, a smaller spacing is present between the drive formation 48 of the tool 40 and the drive formation 18 of the screw 10. Due to this surface contact of the leading side surfaces 58, 28 in the screwing-in direction, mechanical losses when screwing-in the screw 10 are avoided and the screw 10 according to the invention can be screwed in using the tool 40 according to the invention with less energy expenditure than a conventional screw.

The outer surfaces of the drive formation 48 of the tool 40 are advantageously polished. At least the leading side surfaces 58 of the drive formation 48 of the tool 40 in the screwing-in direction have a mean roughness value Rₐ of a maximum of 0.4 μm.

In FIG. 10 a screwing-in force E which is transmitted from the tool 40 to the screw 10 is illustrated. The screwing-in force E is located parallel to the circumferential direction, which is indicated by means of a circumference in dashed lines, to which the screwing-in force E is tangential. The screwing-in force E is transmitted via side surfaces 58 of the drive formation 48 of the tool 40 located obliquely to the circumferential direction and obliquely to the screwing-in force E, and side surfaces 28 of the drive formation 18 of the screw 10 located obliquely to the circumferential direction and to the screwing-in force E. An angle α between the screwing-in force E and the leading side surface 58 of the drive formation 48 of the tool 40 in the screwing-in direction is approximately 35 degrees to 40 degrees in the embodiment shown. According to the invention, this angle can be between 25 degrees and 50 degrees. The angle α is located between the screwing-in force E and the leading side surfaces 28 of the drive formation 18 of the screw 10 in the screwing-in direction, since the side surfaces 58 of the tool 40 bear flat against the side surfaces 28 of the screw 10. The angle α is not constant over all of the side surfaces 58, 28 since the side surfaces 58, 28 are slightly curved. The radius R2 of the side surfaces 58, 28 is larger than the radius of the main body 82 of the drive formation of the screw, see FIG. 13, in particular 1.5 times to 2.5 times, in particular 2 times as large as the radius of the main body and also larger than the radius of a circumference of the drive formation of the screw, see FIG. 13. The side surfaces 58, 28 bear flat against one another.

The screwing-in force E is thus transmitted via the trailing side surfaces 58, 28 in the screwing-in direction. This is due to the fact that, when viewed in the screwing-in direction, with a screw with a right-hand thread and in a plan view of the screw head, the angle α is measured clockwise and is smaller than the complementary angle which is measured counterclockwise.

FIG. 11 shows an enlarged view of the detail Z of FIG. 10. A protuberance 24 is shown and it can be clearly identified in FIG. 11 that the leading side surface 58 of the drive formation 48 in the screwing-in direction bears flat against the leading side surface 28 of the drive formation 18 in the screwing-in direction. A surface contact is advantageously provided over the entire length of the side surfaces 58, 28, parallel to the center longitudinal axis 26. Since only the leading side surfaces 58, 28 in the screwing-in direction bear against one another and in the region of the remaining surfaces of the drive formations 48, 18 a small intermediate space is present between the respective defining surfaces of the drive formations 48, 18, the tool 40 can be introduced easily and with very little effort into the drive formation 18 of the screw 10 and the positive properties of the arrangement according to the invention are still achieved. The screwing-in force E and the angle α are also illustrated.

FIG. 12 shows a screw 70 according to the invention according to a further embodiment of the invention. The screw 70 is configured in a manner very similar to the screw 10 of FIG. 1 and only the features which are different from the screw 10 are described.

Only a drive formation 78 of the screw 70 is different. As can be identified in FIG. 13, but more clearly in FIG. 14 and FIG. 15, the depression 80 of the drive formation 78 is designed cylindrically. An imaginary circumference with the diameter m, see FIG. 15, of the drive formation 78 at the open end of the depression 80 thus has the same diameter m as at the transition to the conical end of the depression 80. Moreover, the drive formation 78 of the screw 70 is configured to be identical to the drive formation 18 of the screw 10 of FIG. 1. The individual features are thus not described again. As a result, a main body 82 of the depression 80 is circular-cylindrical with the diameter y.

The protuberances 84 extending away from the main body 82 are also cylindrical and have the same cross section over their entire length.

FIG. 16 shows a perspective view of a tool 90 according to an embodiment of the invention, wherein the tool 90 has a drive formation 98 which is configured to match the drive formation 78 of the screw 70 of FIGS. 12 to 15. Moreover, the tool 90 is configured to be identical to the tool 40 of FIG. 5 and the individual features which are identical to the tool 40 are thus not described again.

It can be identified from FIGS. 17 and 18 that the drive formation 98 of the tool 90 is configured to be cylindrical and the cross-sectional surface of the drive formation 98 does not change in the direction of the free end of the tool 90, i.e. downwardly in FIG. 18, as far as the transition to the frustoconical end. In particular, the side surfaces of the protuberances 24 are arranged parallel to the center longitudinal axis 26.

An arrangement with the screw 70 of FIG. 12 and the tool 90 of FIG. 16 has advantages, such that an axial force, which pushes the drive formation 98 of the tool 90 out of the drive formation 78 of the screw 70, is not produced when screwing in the screw 70. With very large screws, or screws which have to be screwed in with a high screwing-in torque, an arrangement consisting of the tool 90 and the screw 70 has great advantages.

1. A screw (10; 70) with a shank (12), a thread (14) on at least one portion of the shank (12), wherein the thread (14) defines a screwing-in direction about a center longitudinal axis of the shank (12), and with a drive formation (18; 78) at one end of the shank (12), wherein the drive formation (18; 78) has a depression (20; 80) in a screw head (16) or a projection at the end of the shank (12), wherein the depression (20; 80) or the projection in each case has a circular-cylindrical or frustoconical main body (22;82) arranged concentrically with respect to a center longitudinal axis (26) of the shank (12), and a number of protuberances (24; 84) which extend away from the main body (22; 82), wherein the protuberances (24; 84) are of rounded configuration at their radially outer ends, characterized in that the protuberances (24; 84) extend with a radial component with respect to the center longitudinal axis (26) and with a component which is oriented tangentially and counter to the screwing-in direction.

2. The screw as claimed in claim 1, characterized in that a leading side surface (28) of the protuberances (24; 84) in the screwing-in direction has a larger surface area than a trailing side surface of the protuberances (24; 84) in the screwing-in direction.

3. The screw as claimed in claim 1 or 2, characterized in that between three and six protuberances (24; 84) are provided.

4. The screw as claimed in at least one of the preceding claims, characterized in that the defining surfaces of the protuberances (84) are arranged parallel to the center longitudinal axis.

5. The screw as claimed in at least one of claims 1 to 3, characterized in that the defining surfaces of the protuberances (24) are arranged at an angle of zero degrees to ten degrees, in particular more than zero degrees and less than ten degrees, in particular six degrees, obliquely to the center longitudinal axis (26).

6. The screw as claimed in claim 5, characterized in that the drive formation (18) is configured as a depression (20) and a cross section of the depression reduces in the direction of the screw tip.

7. The screw as claimed in at least one of the preceding claims, characterized in that the drive formation (18; 78) is configured as a depression and a closed end of the recess (20; 80) is of conical configuration.

8. The screw as claimed in claim 5, characterized in that the drive formation is configured as a projection and a cross section of the projection increases in the direction of the screw tip.

9. The screw as claimed in at least one of the preceding claims, characterized in that, when viewed parallel to the center longitudinal axis (26), in all protuberances (24; 84) a tangent or parallel line to the leading side surface (28; 58) of the protuberance (24; 84) in the screwing-in direction encloses an angle (δ) of between 25 degrees and 50 degrees, in particular 35 degrees, with a radial direction which runs through the point of the protuberance (24; 84) located furthest from the outside in the radial direction.

10. The screw as claimed in at least one of the preceding claims, characterized in that, when viewed in a cross section perpendicular to the center longitudinal axis (26), the leading side surfaces (28; 58) of the protuberances (24; 84) in the screwing-in direction are curved outwardly.

11. The screw as claimed in claim 10, characterized in that a radius of curvature of the leading side surfaces (28; 58) in the screwing-in direction is between two times and three times a diameter of the main body (22; 82).

12. The screw as claimed in at least one of the preceding claims, characterized in that, when viewed parallel to the center longitudinal axis (26), a ratio of a diameter of the main body (22; 82) and a diameter of an imaginary circumference of the recess or the projection is a maximum of 1:1.4, in particular 1:1.38.

13. A tool (40; 90) for screwing in and unscrewing a screw as claimed in at least one of the preceding claims, with a drive formation (48; 98) which is configured to match the drive formation (18; 78) of the screw, characterized in that the drive formation (48; 98) has a depression or a projection, wherein the depression or the projection in each case has a circular-cylindrical or frustoconical main body arranged concentrically with respect to a center longitudinal axis (26) of the tool (40; 90), and a number of protuberances (24) which extend away from the main body (22), wherein the protuberances (24) are of rounded configuration at their radially outer ends, wherein relative to the center longitudinal axis (26) the protuberances (24) extend with a radial component with respect to the center longitudinal axis (26) and with a component which is oriented tangentially and counter to the screwing-in direction.

14. The tool as claimed in claim 13, characterized in that at least the leading side surfaces (58) of the protuberances (24) or the projection in the screwing-in direction have a mean roughness value Rₐ of a maximum of 0.4 μm.

15. The tool as claimed in claim 13 or 14, characterized in that the drive formation (48; 98) is configured as a projection and a cross section of the projection reduces in the direction of its free end which is arranged in the depression of the screw.

16. The tool as claimed in claim 15, characterized in that the defining surfaces of the protuberances (24) are arranged at an angle (α) of zero degrees to ten degrees, in particular more than zero degrees and less than ten degrees, in particular six degrees, obliquely to the center longitudinal axis (26).

17. An arrangement with a screw (10) as claimed in one of claims 1 to 12, and a tool (40) as claimed in one of claims 13 to 16, wherein the leading side surfaces (58) of the tool (40) in the screwing-in direction bear flat against the leading side surfaces (28) of the screw (10) in the screwing-in direction when applying a torque in the screwing-in direction by means of the tool (40).

18. The arrangement as claimed in claim 7, characterized in that a screwing-in force (E) acts in the circumferential direction on the side surfaces (58, 28) and in that an angle (α) between the screwing-in force (E) and the side surfaces is between 25 degrees and 50 degrees.

19. The arrangement as claimed in claim 17 or 18, characterized in that the side surfaces (58) of the tool (40) are curved outwardly and the side surfaces (28) of the screw (10) are curved inwardly.

20. The arrangement as claimed in claim 17, 18 or 19, characterized in that, when viewed in the direction of the center longitudinal axis (26) of the tool (40) and screw (10), the leading side surfaces (58) of the tool (40) in the screwing-in direction bear flat over their entire length against the leading side surfaces (28) of the screw (10) in the screwing-in direction.
